(19) United States
(12) Patent Application Publication
(10) Pub. No.: US 2024/0181945 A1
(43) Pub. Date: Jun. 6, 2024

(54) SEAT COVERING MATERIAL AND SEAT

(71) Applicant: Archem Inc., Minato-ku, Tokyo (JP)

(72) Inventor: Kentaro KUNIMOTO, Yokohama-shi, Kanagawa (JP)

(73) Assignee: Archem Inc., Minato-ku, Tokyo (JP)

(21) Appl. No.: 18/552,894

(22) PCT Filed: Dec. 2, 2021
(86) PCT No.: PCT/JP2021/044372

§ 371 Date: Sep. 28, 2023

(30) Foreign Application Priority Data
Apr. 9, 2021 (JP) 2021-066457

(51) Int. Cl. B60N 2/58; B32B 5/18; B32B 9/02

(52) U.S. Cl. CPC B60N 2/5891; B32B 5/18; B32B 9/025

(57) ABSTRACT

A covering material (1) includes an outer layer (2) made of natural leather, a resin foam layer (3) adhered to a back surface of the outer layer (2), and a lining layer (4) provided on a back surface of the resin foam layer (3). In the lining layer (4), slits (5) are formed.

### TECHNICAL FIELD

The present disclosure relates to a seat covering material and a seat.

### BACKGROUND

Conventional seats include, for example, vehicle seats in which a sitter side of a seat pad is covered with a covering material (e.g., see Patent Literature (PTL) 1).

### CITATION LIST

### Patent Literature

PTL 1: JP 2020-081171 A

### SUMMARY

### Technical Problem

However, when a covering material contains natural leather, wrinkles sometimes occur in the covering material.

It would be helpful to provide a seat covering material that can prevent the occurrence of wrinkles, and to provide a seat in which the occurrence of wrinkles is prevented.

### Solution to Problem

A seat covering material according to the present disclosure includes an outer layer made of natural leather, a resin foam layer adhered to a back surface of the outer layer, and a lining layer provided on a back surface of the resin foam layer, wherein in the lining layer, a slit is formed from the lining layer to a position reaching the resin foam layer. The seat covering material according to the present disclosure can prevent the occurrence of wrinkles.

A seat covering material according to the present disclosure includes an outer layer made of natural leather, a resin foam layer adhered to a back surface of the outer layer, and a lining layer provided on a back surface of the resin foam layer, wherein in the lining layer, a hole is formed from the lining layer to a position reaching the resin foam layer. The seat covering material according to the present disclosure can prevent the occurrence of wrinkles.

A seat covering material according to the present disclosure includes an outer layer made of natural leather, a resin foam layer adhered to a back surface of the outer layer, and a lining layer provided on a back surface of the resin foam layer, wherein in the lining layer, a slit and a hole are formed from the lining layer to positions reaching the resin foam layer. The seat covering material according to the present disclosure can prevent the occurrence of wrinkles.

In the seat covering material according to the present disclosure, the slit or the hole can have a depth that does not penetrate the resin foam layer. In this case, the outer layer and the resin foam layer can be kept firmly adhered to each other.

In the seat covering material according to the present disclosure, the slit or the hole can have a depth that penetrates the resin foam layer but does not reach the outer layer. In this case, the flexibility of the covering material can be increased.

A seat according to the present disclosure includes any of the covering materials described above. According to the seat of the present disclosure, the occurrence of wrinkles is prevented.

### Advantageous Effect

According to the covering material of the present disclosure, it is possible to provide a seat covering material that can prevent the occurrence of wrinkles. In addition, according to the seat of the present disclosure, it is possible to provide a seat in which the occurrence of wrinkles is prevented.

### BRIEF DESCRIPTION OF THE DRAWINGS

In the accompanying drawings:

FIG. 1 is a perspective view schematically illustrating a seat according to an embodiment of the present disclosure;

FIG. 2 is a cross sectional view along A-A in FIG. 1;

FIG. 3 is a plan view schematically illustrating a covering material according to an embodiment of the present disclosure from the side of an outer layer of the covering material;

FIG. 4 is a plan view schematically illustrating the covering material in FIG. 3 from the side of a lining layer of the covering material;

FIG. 5 is a cross sectional view along B-B in FIG. 4; and

FIG. 6 is a cross sectional view along C-C in FIG. 4.

### DETAILED DESCRIPTION

A seat covering material, a seat, and a method for manufacturing a seat according to an embodiment of the present disclosure will be described below.

In the present embodiment, a covering material (seat covering material) 1 includes an outer layer 2 made of natural leather, a resin foam layer 3 adhered to a back surface of the outer layer 2, and a lining layer 4 provided on a back surface of the resin foam layer 3. In the lining layer 4, at least one type of slits 5 or holes 6 is formed from the lining layer 4 to positions reaching the resin foam layer 3. In the following description, “above”, “below”, “left”, “right”, “front”, and “back” refer to directions as viewed from a sitter who is sitting in a seat.

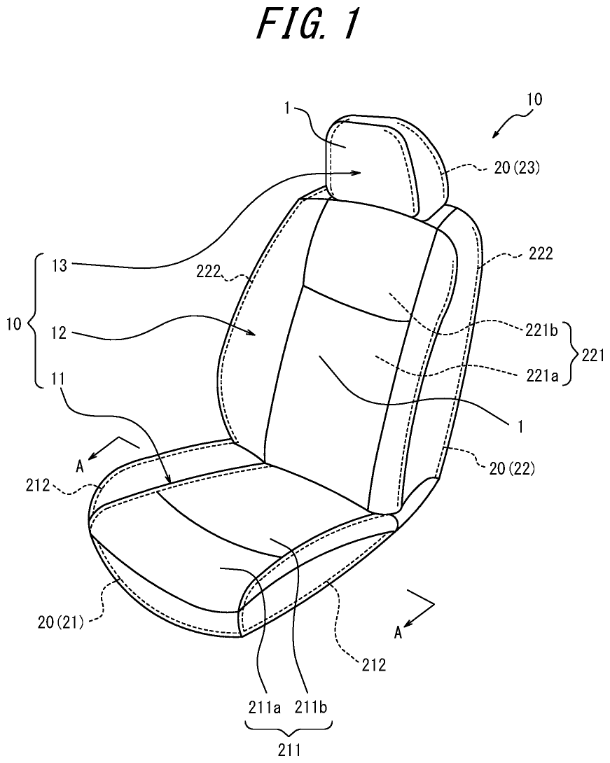

In FIG. 1, the reference numeral 10 indicates a seat according to an embodiment of the present disclosure. The seat 10 can be any type of seat made of natural leather. In the present embodiment, the seat 10 is configured as a vehicle seat (seat for vehicles).

Referring to FIG. 1, the seat 10 includes a covering material 1 and a seat pad 20. The seat pad 20 is formed of resin foam. Examples of a molding material for obtaining the resin foam include soft polyurethane foam, which is a soft polyurethane resin mixed with a foaming agent. However, according to the present disclosure, various foam resins can be used as the molding material. In the present disclosure, a sitter side of the seat pad 20 is covered with the covering material 1. The seat 10 can also include a frame (not illustrated) that is installed on a back side of the seat pad 20.

The seat 10 includes a seat cushion 11 and a seat back 12. In the present embodiment, as illustrated in FIG. 1, the seat 10 can further include a headrest 13 for supporting the head of the sitter.

In the same manner, the seat pad 20 includes a cushion pad 21 and a back pad 22. Furthermore, in the present embodiment, the seat pad 20 can include a head pad 23, as illustrated in FIG. 1.

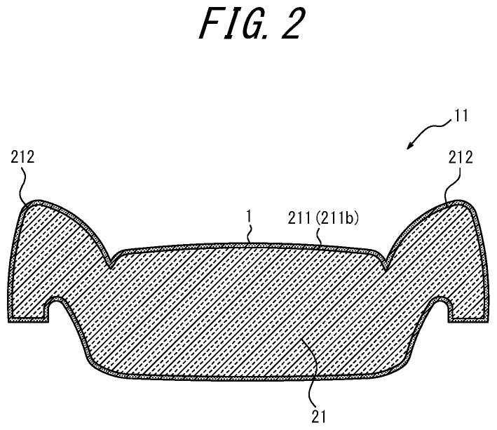

In the seat cushion 11, a sitter side of the cushion pad 21 is covered with the covering material 1. In the present embodiment, the cushion pad 21 has a main pad portion 211 that is configured to support the buttocks and thighs of the sitter from below, and a pair of side pad portions 212 that is located on both right and left sides of the main pad portion 211 and is raised to an upper side of the main pad portion 211 to support the sitter from both the right and left sides. Furthermore, in the present embodiment, the main pad portion 211 includes a lower thigh portion 211a that is configured to support the thighs of the sitter from below, and a lower buttock portion 211b that is located rearwardly relative to the lower thigh portion 211a and configured to support the buttocks of the sitter from below. FIG. 2 illustrates a cross section along A-A in FIG. 1.

Referring to FIG. 1, in the seat back 12, a sitter side of the back pad 22 is covered with the covering material 1. The back pad 22 includes a main pad portion 221 that is configured to support the back of the sitter from back, and a pair of side pad portions 222 that is located on both right and left sides of the main pad portion 221 and is raised to a front side from the main pad portion 221 to support the sitter from both the right and left sides. Furthermore, in the present embodiment, the main pad portion 221 includes a waist portion 221a that is configured to support the waist of the sitter from back, and a shoulder portion 221b that is located above the waist portion 221a and configured to support the shoulders of the sitter from back.

Furthermore, in the present embodiment, in the headrest 13, the sitter side of the head pad 23 is also covered with the covering material 1.

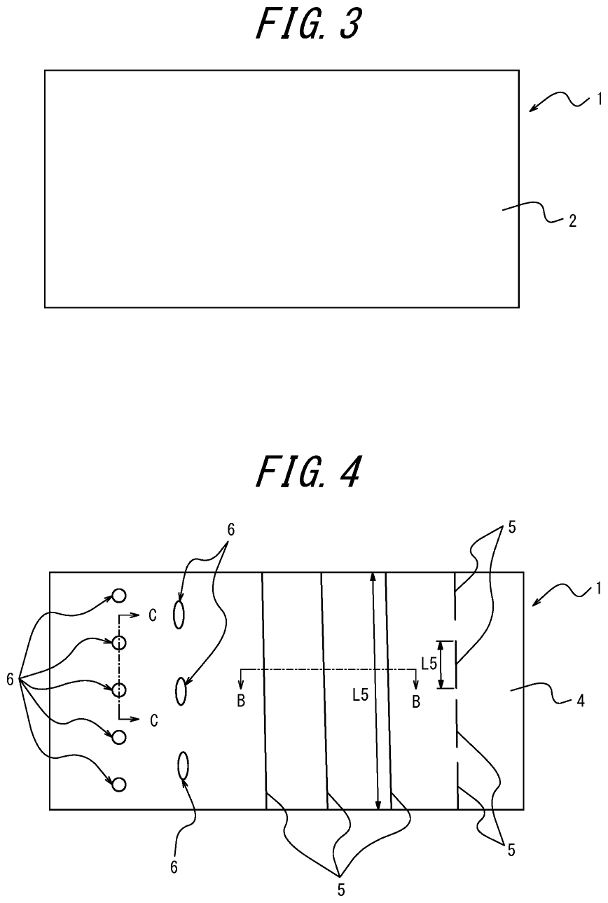

FIG. 3 is a plan view of the covering material 1 schematically illustrated from the outer layer 2. In FIG. 3, the reference numeral 2 indicates the outer layer. The outer layer 2 is a front surface layer facing the sitter side when the covering material 1 is configured as a part of the seat 10. The outer layer 2 is formed of natural leather (genuine leather). Examples of the natural leather include cowhide, horsehide, sheephide, deerhide, ostrich leather, pigskin, and goatskin.

Next, FIG. 4 is a plan view of the covering material 1 schematically illustrated from the lining layer 4. In FIG. 4, the reference numeral 4 indicates the lining layer. The lining layer 4 is a back surface layer facing a seat body side (in the present embodiment, the seat pad 20 side) when the covering material 1 is configured as a part of the seat 10. In the present embodiment, the lining layer 4 is formed of lining fabric. Examples of the lining fabric include woven or non-woven fabrics formed by resins such as nylon.

Referring to FIG. 4, in the present embodiment, slits 5 and holes 6 are formed in the lining layer 4.

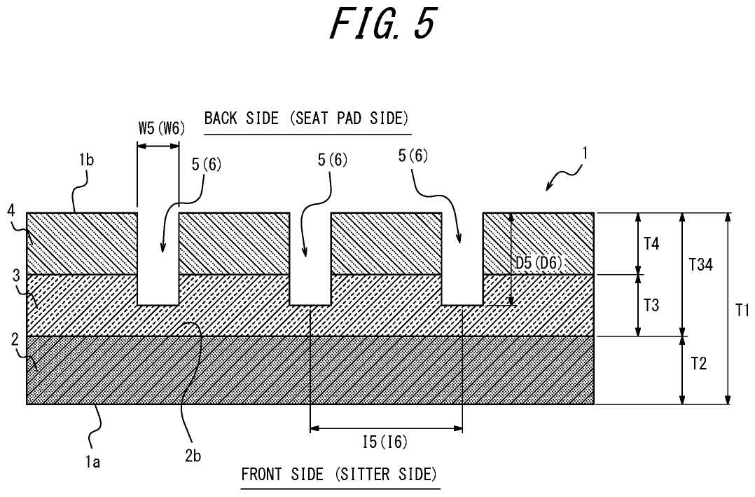

FIG. 5 is a cross sectional view along B-B in FIG. 4. Referring to FIG. 5, the covering material 1 includes the outer layer 2 made of natural leather, the resin foam layer 3 adhered to the back surface of the outer layer 2, and the lining layer 4 provided on the back surface of the resin foam layer 3.

The resin foam layer 3 is formed of resin foam. Examples of a molding material for obtaining the resin foam include soft polyurethane foam, which is a soft polyurethane resin mixed with a foaming agent. However, according to the present disclosure, various foam resins can be used as the molding material. In the present embodiment, for simplicity of structure, the lining layer 4 is adhered to the lining layer 4 by being formed on the resin foam layer 3. However, according to the present disclosure, another layer such as an adhesive layer can be interposed between the resin foam layer 3 and the lining layer 4.

The outer layer 2 is adhered to the resin foam layer 3. The outer layer 2 can be adhered by hot melt adhesion, for example. Examples of a hot melt adhesive include thermoplastic resins, thermosetting resins, moisture curing resins, and the like. The outer layer 2 can also be adhered by a non-woven material (e.g., non-woven fabric) impregnated with the hot melt adhesive.

In the present embodiment, the slits 5 have a depth D5 that does not penetrate the resin foam layer 3. In this case, a large adhesion area between the outer layer 2 and the resin foam layer 3 can be secured. Therefore, according to the present embodiment, the outer layer 2 and the resin foam layer 3 can be kept firmly adhered.

Referring to FIG. 5, the slits 5 have the depth D5 from a back surface (a back surface of the lining layer 4) 1b of the covering material 1 toward a front surface (a front surface of the outer layer 2) 1a of the covering material 1. In the present embodiment, the depth D5 of the slits 5 is shallower than a depth from the back surface 1b of the covering material 1 to a back surface 2b of the outer layer 2. In other words, the dimension of the depth D5 of the slits is shorter than the dimension of the thickness T34 of the resin foam layer 3 and the lining layer 4. Here, the thickness T34 is the thickness between the back surface 1b of the covering material 1 and the back surface 2b of the outer layer 2.

The thickness T3 of the resin foam layer 3 can be 5 mm to 10 mm, for example. The thickness T4 of the lining layer 4 can be 0.2 mm, for example. The thickness T2 of the outer layer 2 can be 0.6 mm to 1.1 mm, for example. Furthermore, the depth D5 of the slits 5 can be 0.1 mm to 1.2 mm, for example. For example, when T2=1.1 mm, T3=5 mm, and T4=0.2 mm, the depth D5 of the slits 5 can be 1.2 mm. The intervals 15 between the slits 5 can be 15=1 cm, for example. Here, the intervals 15 are intervals between the slits 5 in a direction perpendicular to a direction (extension direction of the slits 5) in which the slits 5 extend in plan view of the covering material 1. In the drawing, the intervals 15 are represented as pitch intervals starting from the center of the width W5 of the slits 5.

The depth D5 of the slits 5 can be set as appropriate. For example, the depth D5 can be set in relation to the thickness T34. In the following description, by way of example for simplification, the thickness T34 is assumed to be the sum of the thickness T3 of the resin foam layer 3 and the thickness T4 of the lining layer 4. For example, when the depth D5 of the slits is 0.3 mm and the thickness T34 of the resin foam layer 3 and the lining layer 4 is 5.2 mm (T3=5, T4=0.2), D5:T34=0.3:5.2˜1:17.3. When the depth D5 of the slits 5 is 1.2 mm, D5:T34=1.2:5.2˜1:4.3. When the depth D5 of the slits 5 is 0.3 mm and the thickness T34 of the resin foam layer 3 and the lining layer 4 is 10.2 mm (T3=10, T4=0.2), D5:T34=0.3:10.2˜1:34. When the depth D5 of the slits 5 is 1.2 mm, D5:T34=1.2:10.2˜1:8.5. Similarly, the depth D5 can be set in relation to the thickness T2 of the outer layer 2. For example, when the depth D5 of the slits 5 is 0.3 mm and the thickness T2 of the outer layer 2 is 1.1 mm, D5:T2=0.3:1.1˜1:3.6. When the depth D5 of the slits 5 is 0.3 mm and the thickness T2 of the outer layer 2 is 0.6 mm, D5:T2=0.3:0.6˜1:2. When the depth D5 of the slits 5 is 1.2, D5:T2=1.2:0.6˜2:1. The thickness T2 of the outer layer 2 is the thickness between the front surface 1a of the covering material 1 and the back surface 2b of the outer layer 2. The depth D5 can be set in relation to the thickness T1 of the covering material 1. Here, the thickness T1 of the covering material 1 is the thickness between the back surface 1b of the covering material 1 and the front surface 1a of the covering material 1.

Furthermore, the width W5 of the slits 5 can also be set as appropriate. For example, the dimension of the width W5 of the slits 5 can be set according to the dimensions, shape, area, or the like of the covering material 1. Referring to FIG. 4, in plan view, the length L5 of the slits 5 can also be set as appropriate. For example, the dimension of the length L5 of the slits 5 can also be set according to the dimensions, shape, area, or the like of the covering material 1. Furthermore, the extension direction of the slits 5 can also be set as appropriate according to the dimensions, shape, area, or the like of the covering material 1. Furthermore, at least one slit 5 can be formed for one covering material 1. When the slit 5 includes multiple slits, the arrangement direction and intervals of the slits 5 can also be set according to the dimensions, shape, area, or the like of the covering material 1.

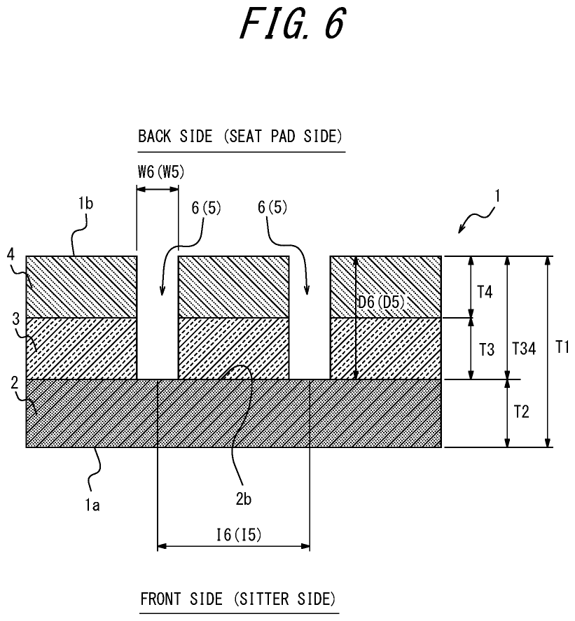

FIG. 6 is a cross sectional view along C-C in FIG. 4. In the present embodiment, the holes 6 have a depth D6 that penetrates the resin foam layer 3 but does not reach the outer layer 2. In this case, the layers (a stacked portion of the resin foam layer 3 and the lining layer 4) other than the outer layer 2 are divided in a thickness direction of the covering material 1. Therefore, according to the present embodiment, the flexibility of the covering material 1 can be increased.

Referring to FIG. 6, the holes 6 have the depth D6 from the back surface 1b of the outer covering material 1 to the back surface 2b of the outer layer 2. In other words, the dimension of the depth D6 of the holes 6 is equal to the dimension of the thickness T34 of the resin foam layer 3 and the lining layer 4. However, as illustrated in FIG. 5, the depth D6 of the holes 6 can be a depth that does not penetrate the resin foam layer 3. Also, as illustrated in FIG. 6, the depth D5 of the slits 5 can be a depth that penetrates the resin foam layer 3 but does not reach the outer layer 2.

Furthermore, the width (e.g., diameter, major axis width, minor axis width, or the like) W6 of the holes 6 can also be set as appropriate. For example, the dimension of the width W6 of the holes 6 can be set according to the dimensions, shape, area, or the like of the covering material 1. Referring to FIG. 4, the shape of the holes 6 in plan view can also be set as appropriate. For example, the holes 6 can be of various shapes, such as perfect circle round holes, oval or other long holes, rhombic or other polygonal holes, and the like. For example, when the holes 6 are round holes, the hole diameter (diameter) of the holes 6 can be 1 mm to 10 mm. When the hole diameter of the holes 6 is 10 mm or less, the covering material 1 is expected to keep its feel after being attached to the seat body. At least one hole 6 can be formed for each covering material 1. When the hole 6 includes multiple holes, the arrangement direction and intervals of the holes 6 can also be set according to the dimensions, shape, area, or the like of the covering material 1.

Referring to FIG. 4, the holes 6 can be at least any one of two cases: perfect circle round holes or oval or other long holes. As illustrated in FIG. 4, the slits 5 can also be formed in at least any one of two cases: formed longitudinally (across) the lining layer 4 or intermittently with respect to the lining layer 4 in plan view. Furthermore, at least any one type of the slits 5 or the holes 6 can be selected.

When a conventional covering material is attached to the seat body (e.g., seat pad 20), wrinkles may subsequently occur in the outer layer 2 of the covering material 1. Such wrinkles occur, for example, at a fixed portion such as an outer edge of the outer layer 2, which is fixed to the seat body, and at a central portion of the outer layer 2 surrounded by the fixed portion.

In contrast, as in the present embodiment, the formation of the slits 5 in the lining layer 4 from the lining layer 4 to positions reaching the resin foam layer 3 can prevent the occurrence of wrinkles after the covering material 1 is attached to the seat body, such as the seat pad 20. The slits 5 can be formed by cutting, such as slitting, the lining layer 4 and the resin foam layer 3 before the outer layer 2 is adhered to the resin foam layer 3. In the present embodiment, the slits 5 are cutting slits.

As in the present embodiment, the formation of the holes 6 in the lining layer 4 from the lining layer 4 to positions reaching the resin foam layer 3 can also prevent the occurrence of wrinkles after the covering material 1 is attached to the seat body, such as the seat pad 20. The holes 6 can be formed, for example, by drilling, such as punching, the lining layer 4 and the resin foam layer 3 before the outer layer 2 is adhered to the resin foam layer 3. In the present embodiment, the holes 6 are punched holes.

Furthermore, as in the present embodiment, the formation of the slits 5 and the holes 6 in the lining layer 4 from the lining layer 4 to positions reaching the resin foam layer 3 can prevent the occurrence of wrinkles after the covering material 1 is attached to the seat body, such as the seat pad 20.

The positions, density, and number of the slits 5 and the holes 6 can be set as appropriate.

The seat 10 includes the covering material 1. Therefore, the seat 10 according to the present embodiment is a seat in which the occurrence of wrinkles is prevented.

Next, as a method for manufacturing a seat according to the present embodiment, a method for manufacturing a seat, for manufacturing the seat 10 including the covering material 1 will be described.

The method for manufacturing a seat according to the present embodiment includes attaching the above-described covering material 1 to the seat body. According to the method for manufacturing a seat of the present embodiment, the seat 10 in which the occurrence of wrinkles is prevented can be easily obtained.

In the present embodiment, the seat pad 20 is prepared as the seat body described above. Then, by using the same method as before, the seat pad is covered with the covering material 1. Thereby, the seat 10 in which the occurrence of wrinkles is prevented can be easily obtained.

As described above, according to the covering material 1, it is possible to provide a seat covering material that can prevent the occurrence of wrinkles. Also, according to the seat 10, it is possible to provide a seat in which the occurrence of wrinkles is prevented.

The above is only examples of one embodiment of the disclosure, and various changes are possible in accordance with the scope of the claims. Furthermore, the various configurations employed in the present embodiment can be selectively omitted as appropriate, for example, by forming only the slits 5 in the seat covering material 1, or by forming only the holes 6 in the seat covering material 1.

### REFERENCE SIGNS LIST

1 seat covering material
2 outer layer
3 resin foam layer
4 lining layer
5 slit
6 hole
10 seat
11 seat cushion
12 seat back
13 headrest
20 seat pad
21 cushion pad
22 back pad
23 head pad

1. A seat covering material comprising:
an outer layer made of natural leather;
a resin foam layer adhered to a back surface of the outer layer; and
a lining layer provided on a back surface of the resin foam layer,
wherein in the lining layer, a slit is formed from the lining layer to a position reaching the resin foam layer.

2. A seat covering material comprising:
an outer layer made of natural leather;
a resin foam layer adhered to a back surface of the outer layer; and
a lining layer provided on a back surface of the resin foam layer,
wherein in the lining layer, a hole is formed from the lining layer to a position reaching the resin foam layer.

3. A seat covering material comprising:
an outer layer made of natural leather;
a resin foam layer adhered to a back surface of the outer layer; and
a lining layer provided on a back surface of the resin foam layer,
wherein in the lining layer, a slit and a hole are formed from the lining layer to positions reaching the resin foam layer.

4. The seat covering material according to claim 1, wherein the slit or the hole has a depth that does not penetrate the resin foam layer.

5. The seat covering material according to claim 1, wherein the slit or the hole has a depth that penetrates the resin foam layer but does not reach the outer layer.

6. A seat comprising the covering material according to claim 1.

7. The seat covering material according to claim 2, wherein the slit or the hole has a depth that does not penetrate the resin foam layer.

8. The seat covering material according to claim 3, wherein the slit or the hole has a depth that does not penetrate the resin foam layer.

9. The seat covering material according to claim 2, wherein the slit or the hole has a depth that penetrates the resin foam layer but does not reach the outer layer.

10. The seat covering material according to claim 3, wherein the slit or the hole has a depth that penetrates the resin foam layer but does not reach the outer layer.

11. A seat comprising the covering material according to claim 2.

12. A seat comprising the covering material according to claim 3.

13. A seat comprising the covering material according to claim 4.

14. A seat comprising the covering material according to claim 5.
